(19) United States
(12) Patent Application Publication
(10) Pub. No.: US 2003/0132052 A1
(43) Pub. Date: Jul. 17, 2003

(54) Control of vehicle steering following a high speed blowout

(76) Inventor: William A. Simpson, Reseda, CA (US)

Correspondence Address: William A. Simpson, 7241 Yolanda Ave, Reseda, CA, 91335, US

(21) Appl. No.: 10/086,819

(22) Filed: Mar. 4, 2002

Related U.S. Application Data
(60) Provisional application No. 60/348,264, filed on Jan. 15, 2002.

(51) Int. Cl. B62D 5/00

(52) U.S. Cl. 180/404

(57) ABSTRACT

A system for inducing inertia into a vehicles' steering gear. Following a high speed blowout the added inertia will hold the front wheels steady in their pre-blowout direction. The added inertia will prevent a reverse power flow from the front wheels to the steering wheel following a high speed blowout. The conventional power steering of the vehicle will be strengthened so that the operation of the steering wheel by the driver will easily overcome the increased inertia of the vehicles' steering gear.

### CROSS REFERENCE TO RELATED APPLICATIONS

NOT APPLICABLE.

### STATEMENT REGARDING FEDERALLY SPONSORED RESEARCH OR DEVELOPMENT

NOT APPLICABLE.

### REFERENCE TO A “MICROFICHE APPENDIX”

Not applicable.

### TECHNICAL FIELD

1. Field of Invention

This invention relates to the steering of a vehicle during the first one second following a high speed blowout.

One second is the approximate reaction time of a driver to a blowout. This is the time it takes for a driver to re-gain control of the vehicle after a blowout.

During this brief “out of control” period a vehicle can travel 100 feet or more and veer off the highway.

2. Background Art

The magnitude of the forces acting on the front wheels of the vehicle during this “out of control” period will depend upon the speed of the vehicle, the weight of the vehicle and the surface of the road.

This invention will hold the front wheels steady in the direction they are rolling at the instant of the blowout.

The front wheels are prevented from turning during the critical one second “out of control” period while the driver reacts to control the vehicle. Thus the stability of the vehicle will be controlled following either a front tire or rear tire blowout at high speed.

### BRIEF SUMMARY OF THE INVENTION

Control of the steering is accomplished by providing braking to the vehicles' steering gear. This controlled braking of the steering gear mechanism will prevent any movement of the vehicles' front wheels by forces generated at the time of the blowout. The front wheels will remain steady in their pre-blowout direction.

This invention is designed on the premise that the conventional power steering of the vehicle will be strengthened so that the operation of the steering wheel by the driver will easily overcome the braking on the vehicles' steering gear.

This invention prevents a reverse power flow along the steering gear shaft from the front wheels to the steering wheel following a high speed blowout.

After a driver regains control of the steering following a blowout, the power flow along the steering gear shaft will be normal from the steering wheel to the front wheels.

The power steering of the vehicle will be capable of multiplying the drivers torque on the steering wheel so that the driver can easily overcome the inertia of the retarded steering gear.

The desired braking on the steering gear mechanism can be accomplished hydraulically, electrically or mechanically.

### BRIEF DESCRIPTION OF THE DRAWINGS

Drawings may not be necessary for this application. There are no proposals to change the steering gear other than to strengthen the mechanism and increase the power steering assist.

### DETAILED DESCRIPTION OF THE INVENTION

The controlled braking may be applied to the steering gear shaft through an electromagnetic clutch or a mechanical brake. However, the preferred method may be the use of a positive displacement hydraulic device connected to the steering gear shaft.

The precise retarding of the steering gear mechanism can then be accomplished through a flow control valve in a pipe connecting the outlet port and the inlet port of a hydraulic device such as a rotary gear pump-motor.

The amount of retardation on the steering gear mechanism will depend on the setting of the flow control valve which controls the circulation of oil within the positive displacement pump-motor.

As the flow control valve is closed, friction of the oil circulating within the pump-motor is increased, resulting in a greater torque required to turn the rotary gear pump-motor.

The pump-motor is connected to the steering gear shaft and thus indirectly to the front wheels. The forces acting on the front wheels following a blowout will now be unable to move the front wheels from their pre-blowout direction.

The flow control valve will be set so that the holding force on the front wheel due to the inertia of the steering gear will be greater than any force that acts to turn the front wheels immediately following a blowout. The front wheels will remain steady in their pre-blowout direction during the critical one second reaction time of the driver to the blowout.

When the driver is again in control of the steering, the power steering assist will override the inertia of the steering gear and the steering of the vehicle will be normal.

At low vehicle speeds when the control of a vehicle is not seriously affected by a blowout, the flow control valve can be set at the full open position. The oil circulation between the outlet and inlet ports of the positive displacement hydraulic device will encounter little resistance. The torque required from the steering gear shaft to turn the hydraulic pump-motor will be at a minimum. The vehicles steering system will again function as a low inertia conventional steering gear.

With the flow control valve set in the full open position the driver will be able to steer the vehicle manually should the power steering assist fail.

1. A system for inducing inertia into a vehicles' steering gear, comprising:
a. the connecting of a controlled braking device to said vehicles steering gear.
b. means for controlling the amount of braking generated by said controlled braking device,
whereby said inertia will be induced into said vehicles' steering gear.
